(19) United States
(12) Patent Application Publication
(10) Pub. No.: US 2009/0014256 A1
(43) Pub. Date: Jan. 15, 2009

(54) Elevator Apparatus and Method of Controlling the Apparatus

(75) Inventor: Tatsuo Matsuoka, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: MITSUBISHI DENKI KABUSHIKI KAISHA, Tokyo (JP)

(21) Appl. No.: 10/576,472

(22) PCT Filed: Apr. 6, 2004
(86) PCT No.: PCT/JP04/04954

§ 371 Date: Apr. 20, 2006

(51) Int. Cl. B66B 1/34

(52) U.S. Cl. 187/393

(57) ABSTRACT

An elevator apparatus has an elevator control apparatus having an operation control portion that controls operation of a car and a supervising portion that detects an abnormality in a movement of the car. When the supervising portion performs initial setting, the operation control portion causes the car to travel at a lower speed than the speed at a time of normal operation according to each phase of the initial setting.

### TECHNICAL FIELD

The present invention relates to an elevator apparatus that requires initial setting of a supervising portion at the time of activation or the like, and to a control method for the elevator apparatus.

### BACKGROUND ART

For example, JP2003-104646A discloses a conventional elevator apparatus in which the set speed for operating a safety device is continuously changed according to the position of a car. More specifically, in this elevator apparatus, the position of the car is detected by an encoder, and the safety device is operated at a lower set-speed in an upper-end region and a lower-end region within a hoistway than in an intermediate region. Thus, the stroke of a buffer installed in a lower portion of the hoistway is reduced.

In the conventional elevator apparatus as described above, the position of the car is detected as the number of accumulated pulses from a reference position within the hoistway. Therefore, for example, when the elevator apparatus is activated or when the position of the car changes for some reason, it is necessary to move the car within the hoistway and perform an initial setting operation.

However, supervision corresponding to the position of the car cannot be carried out during the initial setting operation. Therefore, the car may collide with the buffer at a speed higher than a permissible collision speed so the car and the buffer may be damaged, for example, when some abnormality occurs during the initial setting operation.

### DISCLOSURE OF THE INVENTION

The present invention is made to solve the problem mentioned above and has an object of obtaining an elevator apparatus and a control method therefor which can more reliably prevent a car from colliding with a buffer at a speed higher than a permissible collision speed.

An elevator apparatus according to the present invention includes an elevator control apparatus having an operation control portion that controls operation of a car and a supervising portion that detects abnormalities in a movement of the car. When the supervising portion performs initial setting, the operation control portion causes the car to travel at a lower speed than a speed at a time of normal operation according to each phase of the initial setting.

Further, a control method for an elevator apparatus according to the present includes an initial setting operation step of performing initial setting of a supervising portion detecting abnormalities in the movement of the car while causing the car to travel. In the initial setting operation step, the car is caused to travel at a lower speed than a speed at a time of normal operation according to each phase of initial setting.

### BRIEF DESCRIPTION OF THE DRAWINGS

FIG. 1 is a schematic diagram showing an elevator apparatus according to an embodiment of the present invention.

FIG. 2 is a graph showing a speed supervising pattern of an emergency terminal speed-limiting device shown in FIG. 1.

FIG. 3 is an explanatory view showing a relationship between a phase of an initial setting operation of the emergency terminal speed-limiting device shown in FIG. 1 and operations of an operation control portion and a safety circuit.

FIG. 4 is an explanatory view explaining movements of a car in an initial setting operation mode of the elevator apparatus shown in FIG. 1.

### BEST MODE FOR CARRYING OUT THE INVENTION

A preferred embodiment of the present invention will be described hereinafter with reference to the drawings.

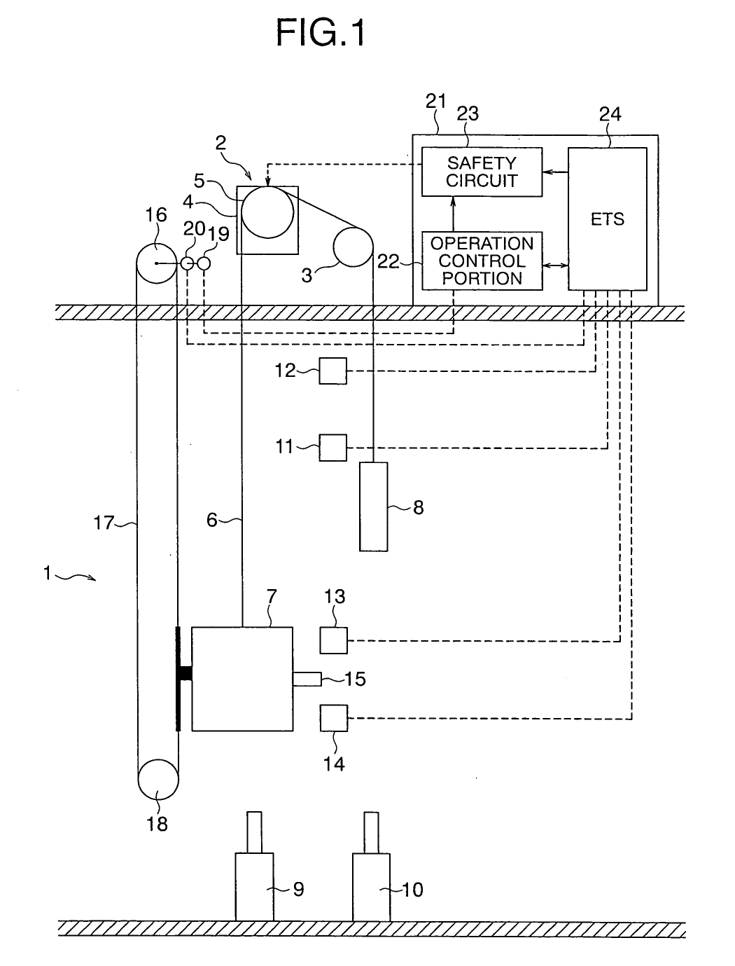

FIG. 1 is a schematic diagram showing an elevator apparatus according to an embodiment of the present invention. Referring to the figure, a drive unit (hoisting machine) 2 and a deflector sheave 3 are disposed in an upper portion of a hoistway 1. The drive unit 2 has a drive unit main body 4 including a motor and a brake, and a drive sheave 5 rotated by the motor of the drive unit main body 4.

A plurality of main ropes 6 (only one of them is shown in FIG. 1) are wound around the drive sheave 5 and the deflector sheave 3. A car 7 is connected to one end portion of each of the main ropes 6. A counterweight 8 is connected to the other end portion of each of the main ropes 6. That is, the car 7 and the counterweight 8 are suspended within the hoistway 1 according to a one-to-one roping method by means of the main ropes 6. The car 7 and the counterweight 8 are moved upward and downward within the hoistway 1 by a driving force of the drive unit 2.

A buffer 9 for the car and a buffer 10 for the counterweight are installed in a lower portion (bottom portion) of the hoistway 1. The buffer 9 for the car is disposed directly below the car 7, and the buffer 10 for the counterweight is disposed directly below the counterweight 8. Hydraulic shock absorbers are used as the buffer 9 for the car and the buffer 10 for the counterweight.

A first top terminal landing switch 11 and a second top terminal landing switch 12 are installed in the vicinity of a top terminal landing within the hoistway 1. The second top terminal landing switch 12 is disposed above the first top terminal landing switch 11.

A first bottom terminal landing switch 13 and a second bottom terminal landing switch 14 are installed in the vicinity of a bottom terminal landing within the hoistway 1. The second bottom terminal landing switch 14 is disposed below the first bottom terminal landing switch 13.

Mounted to the car 7 is a car-side plate 15 that operates the terminal landing switches 11 to 14 according to the movements of the car 7.

A rotatable governor sheave 16 is provided in an upper portion of the hoistway 1. An upper end portion of an endless governor rope 17 is wound around the governor sheave 16. A lower end portion of the governor rope 17 is wound around a tension sheave 18 that applies a tensile force to the governor rope 17. The tension sheave 18 is disposed in a lower portion within the hoistway 1. The governor rope 17 is connected to the car 7. Accordingly, the governor rope 17 is moved in a circulating manner as the car 7 travels. Further, the governor sheave 16 is rotated as the car 7 travels.

The governor sheave 16 is provided with a first governor encoder 19 as a control position sensor and a second governor encoder 20 as a supervision position sensor.

An elevator control apparatus (control panel) 21 is provided in the upper portion of the hoistway 1. The elevator control apparatus 21 is provided with an operation control portion 22, a safety circuit 23, and an emergency terminal speed limiting device (ETS) 24 as a supervising portion 24.

The operation control portion 22 selectively changes over a plurality of operation modes and controls the car 7, namely, the drive unit 2. The operation modes of the operation control portion 22 include a normal operation mode, an initial setting operation mode for performing initial setting of the emergency terminal speed-limiting device 24 while causing the car 7 to travel, and a maintenance operation mode.

A signal from the first governor encoder 19 is input to the operation control portion 22. Further, the operation portion 22 detects the position and the speed of the car 7 referring to a signal from the first governor encoder 19.

Signals from the second governor encoder 20 and the terminal landing switches 11 to 14 are input to the emergency terminal speed-limiting device 24. The emergency terminal speed-limiting device 24 detects an abnormality in the elevator. More specifically, the emergency terminal speed-limiting device 24 forcibly decelerates and stops the car 7 via the safety circuit 23 when the car 7 approaches the vicinity of a terminal landing at a speed higher than a preset speed.

Since the emergency terminal speed-limiting device 24 is used, shortened buffers, which are shorter than a buffer for the case where the emergency terminal speed-limiting device 24 is not used, are used as the buffer 9 for the car and the buffer 10 for the counterweight.

Further, the emergency terminal speed-limiting device 24 detects the position and the speed of the car 7 independently of the operation control portion 22, referring to a signal from the second governor encoder 20.

Furthermore, in the initial setting operation mode, the operation control portion 22 causes the car 7 to travel at a lower speed than in the normal operation mode, according to each phase of the initial setting. More specifically, in the initial setting operation mode, the operation control portion 22 causes the car 7 to travel at a speed equal to or lower than a permissible collision speed of the buffer 9 for the car and the buffer 10 for the counterweight as shortened buffers.

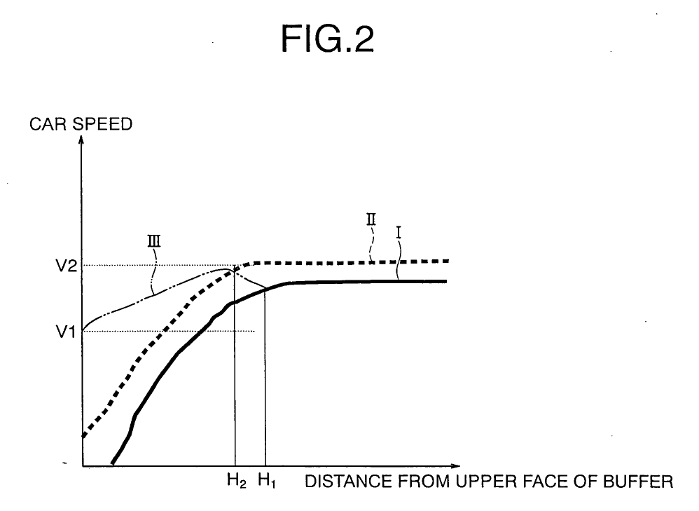

FIG. 2 is a graph showing a speed supervising pattern of the emergency terminal speed-limiting device 24 shown in FIG. 1. Illustrated in FIG. 2 is a relationship between the distance from an upper face of the buffer 9 for the car and the speed of the car. Referring to FIG. 2, a curve I indicated by a solid line represents a pattern according to which the car travels to the terminal landing at a rated speed (normal speed).

Further, a curve II indicated by a broken line represents a set value pattern according to which the terminal speed-limiting device 24 performs forcible deceleration. That is, when the speed of the car 7 exceeds the curve II, the emergency terminal speed-limiting device 24 forcibly decelerates the car 7.

The set value at which the emergency terminal speed-limiting device 24 performs forcible deceleration changes according to the position from the upper face of the buffer 9 for the car. That is, the control apparatus is so set as to perform forcible deceleration at a lower speed in the vicinity of the buffer 9 for the car.

Further, reference symbol V1 represents a permissible collision speed of the shortened buffers in the case where the emergency terminal speed-limiting device 24 is used. Furthermore, reference symbol V2 represents a permissible collision speed of a normal buffer that is used in the case where the emergency terminal speed-limiting device 24 is not used. The shortened buffers are lower in permissible collision speed than the normal buffer but has a smaller length dimension than the normal buffer. Therefore, the use of the shortened buffers makes it possible to reduce the depth dimension of the bottom portion of the hoistway 1.

Thus, since the permissible collision speed V1 is low, the control apparatus is so set as to perform forcible deceleration at a lower speed in the vicinity of the buffer 9 for the car, which enables deceleration to the permissible collision speed V1 even at a short distance.

Referring to FIG. 2, a curve III indicated by a chain double-dashed line represents a pattern in the case where the speed of the car 7 exceeds the set value of the emergency terminal speed-limiting device 24 for some reason. According to the pattern III, the speed of the car 7 suddenly increases at a distance H1 from the upper face of the buffer 9, and exceeds the set value at a distance H2. When the speed of the car 7 exceeds the set value, the emergency terminal speed-limiting device 24 shuts off the safety circuit 23, thus decelerating the car 7. The car 7 then collides with the buffer 9 at the permissible collision speed V1 of the shortened buffers.

Next, an initial setting operation of the emergency terminal speed-limiting device 24 is described. As described above, the emergency terminal speed-limiting device 24 detects the position of the car 7 independently of the operation control portion 22. Therefore, the initial setting operation (initial setting operation step) of the emergency terminal speed-limiting device 24 needs to be performed, for example, when the elevator is activated. Further, the initial setting operation of the emergency terminal speed-limiting device 24 needs to be performed also when a discrepancy has arisen between positional information on the car 7 in the operation control portion 22 and positional information on the car 7 in the emergency terminal speed-limiting device 24. In performing the initial setting operation described above, the operation mode of the operation control portion 22 is changed over to the initial setting operation mode.

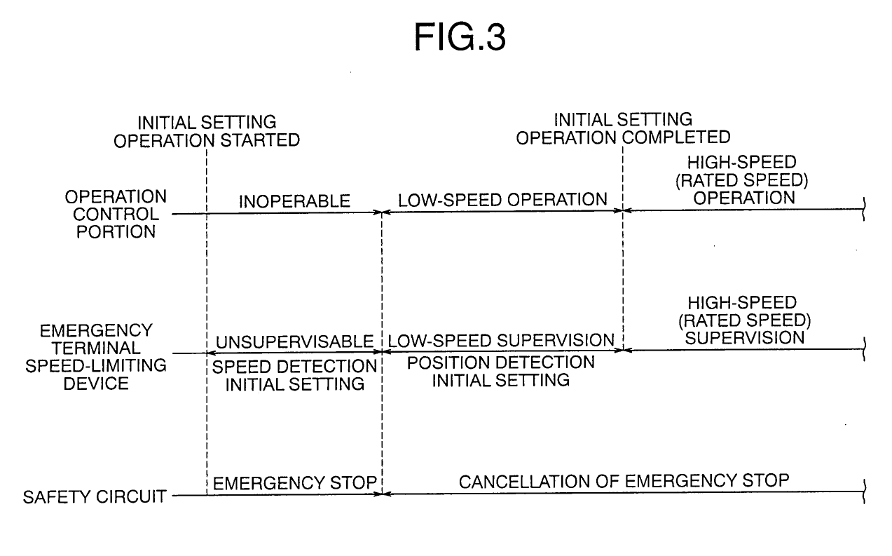

FIG. 3 is an explanatory view showing a relationship between the phase of the initial setting operation of the emergency terminal speed-limiting device 24 shown in FIG. 1 and the operations of the operation control portion 22 and the safety circuit 23. In the initial setting operation, speed detection initial setting is first performed and position detection initial setting is then performed.

When starting the initial setting operation, the safety circuit 23 holds the drive unit 2 in an emergency stop state. That is, a motor power supply of the drive unit 2 is shut off, and a brake of the drive unit 2 is applied. Further, a command of inoperability is output to the operation control portion 22 from the emergency terminal speed-limiting device 24.

The safety circuit 23 remains in the emergency stop state and the operation control portion 22 remains inoperable until the speed detection initial setting is terminated. Therefore, the emergency terminal speed-limiting device 24 cannot perform supervision.

When the speed detection initial setting is terminated, a permission signal permitting low-speed operation is output to the operation control portion 22 from the emergency terminal speed-limiting device 24. Further, the emergency stop state of the safety circuit 23 is canceled. In this state, the emergency terminal speed-limiting device 24 performs the position detection initial setting operation.

In the position detection initial setting operation, the car 7 is caused to travel from the lower portion to the upper portion of the hoistway 1 at a speed equal to or lower than the permissible collision speed of the buffers 9 and 10. Then in the emergency terminal speed-limiting device 24, a relationship is set between the signal from the second governor encoder 20 and the position of the car 7 within the hoistway 1.

When the initial setting operation is terminated, a permission signal enabling high-speed (rated speed operation) operation is output from the emergency terminal speed-limiting device 24 to the operation control portion 22. Further, high-speed supervision is enabled in the emergency terminal speed-limiting device 24.

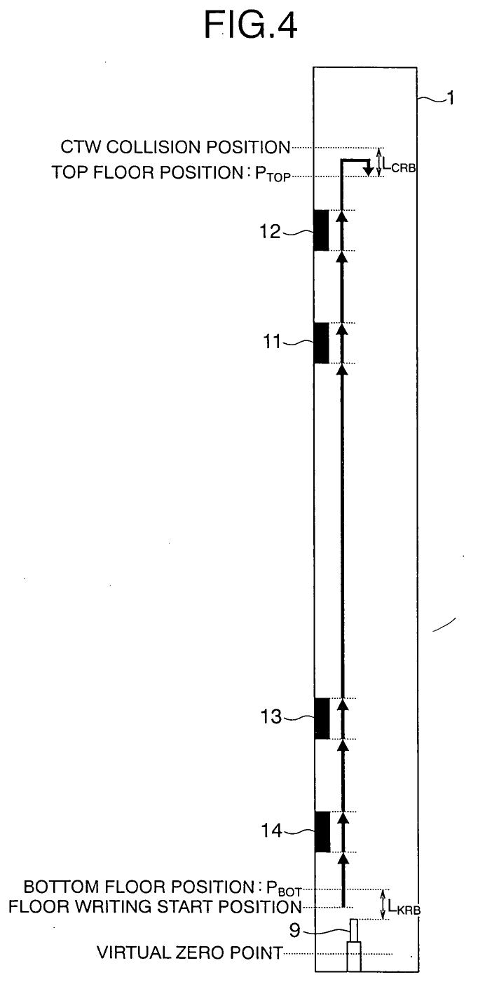

FIG. 4 is an explanatory view showing movements of the car 7 in the initial setting operation mode of the elevator apparatus shown in FIG. 1. In the initial setting operation mode, after speed detection initial setting has been terminated, the car 7 is moved to a floor writing start position in the lower portion of the hoistway 1. The floor writing start position is a position of the car 7 which is below a bottom floor position P_{BOT} and above the car-side buffer 9. Further, when the car 7 is located at the floor writing start position, the car-side plate 15 is located below a second bottom terminal landing switch 14.

Within the hoistway 1, a plurality of terminal switches (not shown) are provided such that the operation control 22 detects the positions of a bottom floor and a top floor. The operation control portion 22 controls the movement of the car 7 to the floor writing start position.

After that, while the car 7 is moved upward from the floor writing start position, a provisional current position P_{current tmp} of the car 7 corresponding to a signal from the second governor encoder 20 is calculated. More specifically, the floor writing start position is set to 0.

P_{current tmp}←0

After that, the provisional current position is updated at intervals of a calculation cycle (e.g., 100 milliseconds).

The emergency terminal speed-limiting device 24 is provided with an up-down counter counting the number of encoder pulses of the second governor encoder 20. Given that GC1 represents a movement amount within the calculation cycle of the up-down counter, the provisional current position P_{current tmp} in the N-th calculation cycle is calculated as follows.

P_{current tmp N}←P_{current tmp N-1}+GC1

More specifically, the provisional current position or the movement amount within the calculation cycle is calculated as the number of encoder pulses.

Thus, the provisional current position is updated as the car 7 moves upward. Positions corresponding to entry of the car-side plate 15 into the periphery of the terminal landing switches 11 to 14 and positions corresponding to the exit of the car-side plate 15 from the periphery of the terminal landing switches 11 to 14 are written into a table of a storage portion (memory) provided in the emergency terminal speed-limiting device 24.

For instance, given that entry into the periphery of the second bottom terminal landing switch 14 is detected in the N-th calculation cycle, an entry position P_{tmp ETSD} is calculated as follows.

P_{tmp ETSD}←P_{current tmp N-1}+GC1−GC2

It should be noted that GC2 represents the movement amount of the up-down counter after entry of the car-side plate 15 into the periphery of the second bottom terminal landing switch 14.

The positions of entry of the car-side plate 15 into the periphery of the other terminal landing switches 11, 12, and 13 are also written into the table in a similar manner.

For instance, given that exit from the periphery of the second bottom terminal landing switch 14 is detected in the N-th calculation cycle, an exit position P_{tmp ETSU} is calculated as follows.

P_{tmp ETSU}←P_{current tmp N-1}+GC1−GC3

It should be noted that GC3 represents the movement amount of the up-down counter after exit of the car-side plate 15 from the periphery of the second bottom terminal landing switch 14.

The positions of exit of the car-side plate 15 from the periphery of the other terminal landing switches 11, 12, and 13 are also written into the table in a similar manner.

Thus, after all the entry positions and the exit positions have been written into the table, the car 7 is stopped at top floor position P_{TOP}.

Data on a bottom floor position P_{BOT} and the top floor position P_{TOP} based on a virtual zero point are set in the operation control portion 22. When the car 7 is stopped at the top floor position P_{TOP}, the data on the bottom floor position P_{BOT} and the top floor position P_{TOP} based on the virtual zero point are transmitted from the operation control portion 22 to the emergency terminal speed-limiting device 24. In the emergency terminal speed-limiting device 24, the position data that have been calculated as the provisional current positions and written into the table are converted into data based on the virtual zero point, on the basis of information transmitted from the operation control portion 22. This makes it possible to detect a current position P_{current} based on the virtual zero point.

A correction amount δ to the current position is calculated as follows.

δ=P_{TOP}−P_{current tmp N}

Accordingly, the position data, based on the virtual zero point, can be calculated by adding the correction amount δ to the position data written into the table. The post-correction position data is written into an E²PROM of the emergency terminal speed-limiting device 24 and used thereafter.

Further, when the car 7 is stopped on the top floor, the following processings are performed to make a shift in position management from the provisional current position to the current position.

P_{current 0}←P_{TOP}

P_{current N}←P_{current N-1}+GC1

After this correction has been completed and the shift in position management to the current position management has been made, a command enabling high-speed operation is output from the emergency terminal speed-limiting device 24 to the operation control portion 22, so that the performance of high-speed automatic operation, namely, the normal operation mode is permitted. Further, the emergency terminal speed-limiting device 24 performs a normal supervising operation. In the normal supervising operation, a distance L1 between the car 7 and the upper face of the buffer 9 for the car and a distance L2 between the counterweight 8 and the upper face of the buffer 10 for the counterweight are calculated for each calculation cycle according to the following equations.

L1=P_{current N}−(P_{BOT}−L_{KRB})

L2=(P_{TOP}−L_{CRB})−P_{current N}

It should be noted that L_{KRB} represents the distance from the upper face of the buffer 9 for the car to the bottom floor position P_{BOT}, and that L_{CRB} represents the distance from the top floor position P_{TOP} to the position of the car 7 at the time when the counterweight 8 collides with the buffer 10 for the counterweight (a CWT collision position shown in FIG. 4).

The elevator apparatus described above causes the car 7 to travel at a speed equal to or lower than the permissible collision speed of the buffer 9 for the car until the completion of the initial setting operation, and thus makes it possible to more reliably prevent the car 7 from colliding with the buffer 9 for the car at a speed higher than the permissible collision speed and to achieve reliability enhancement.

The aforementioned example shows the case of performing the initial setting operation in two stages, that is, speed detection initial setting and position detection initial setting. However, it is also appropriate to perform the initial setting operation in three or more phases and set a permissible traveling speed of the car for each of the phases individually.

Further, the initial setting operation should not be limited to speed detection initial setting and position detection initial setting.

Furthermore, the emergency terminal speed-limiting device is mentioned as the supervising portion in the aforementioned example. However, the supervising portion should not be limited thereto and may be a unit for detecting, for example, the overspeed or vibration of the car.

1. An elevator apparatus comprising an elevator control:
apparatus having an operation control portion that controls operation of a car and a supervising portion that detects abnormalities in the movement of the car,
wherein when the supervising portion performs initial setting, the operation control portion causes the car to travel at a lower speed than a speed at a time of normal operation according to each phase of the initial setting.

2. An elevator apparatus according to claim 1, wherein the supervising portion outputs a permission signal regarding a speed of the car to the operation control portion according to each phase of the initial setting.

3. An elevator apparatus according to claim 1, wherein the operation control portion selectively changes over a plurality of operation modes including a normal operation mode and an initial setting operation mode for performing initial setting of the supervising portion while causing the car to travel, and controls operation of the car, and
wherein in the initial setting operation mode, the operation control portion causes the car to travel at a lower speed than a speed in the normal operation mode according to each phase of the initial setting.

4. An elevator apparatus according to claim 1, wherein the supervising portion comprises an emergency terminal speed-limiting device for forcibly decelerating and stopping the car when the car approaches a vicinity of a terminal landing at a speed higher than a preset speed.

5. An elevator apparatus according to claim 4, wherein use of the emergency terminal speed-limiting device enables installation of a shortened buffer that receives the car in a lower portion within a hoistway, and
wherein, the operation control portion causes the car to travel at a speed equal to or lower than a permissible collision speed of the shortened buffer in performing initial setting of the supervising portion.

6. An elevator apparatus according to claim 1, further comprising a control position sensor for detecting a position of the car within a hoistway and a supervision position sensor connected to the supervising portion to detect a position of the car within the hoistway,
wherein, a relationship between a signal from the supervision position sensor and a position of the car within the hoistway is set in performing initial setting of the supervising portion.

7. A control method for an elevator apparatus comprising an initial setting operation step of performing initial setting of a supervising portion detecting abnormalities in a movement of a car while causing the car to travel,
wherein in the initial setting operation step, the car is caused to travel at a lower speed than a speed at a time of normal operation according to each phase of the initial setting.
